(19) United States
(12) Patent Application Publication
(10) Pub. No.: US 2026/0135171 A1
(43) Pub. Date: May 14, 2026

(54) PD PROTOCOL-BASED CHARGING AND DISCHARGING COMMON INTERFACE GARDEN BATTERY PACK

(71) Applicant: Xiangfen LI, Heihe (CN)

(72) Inventor: Xiangfen LI, Heihe (CN)

(21) Appl. No.: 19/444,113

(22) Filed: Jan. 8, 2026

(51) Int. Cl. H01M 10/46; H01M 10/42; H01M 50/247; H02J 7/47

(52) U.S. Cl. CPC H01M 10/46; H01M 10/425; H01M 50/247; H02J 7/47; H01M 2220/30

(57) ABSTRACT

A PD protocol-based charging and discharging common interface garden battery pack is provided, including: an MCU control unit, wherein the MCU control unit is configured to perform logical control over the circuitry and further includes an MCU chip; a PD charge/discharge management unit for controlling charge/discharge logic, which includes a charge/discharge management chip electrically connected to the MCU chip to form a signal pathway; a battery pack unit for energy storage or discharge, connected to the MCU control unit and the PD charge/discharge management unit.

### FIELD

The present disclosure relates to the technical field of gardening tools, specifically to a PD protocol-based charging and discharging common interface garden battery pack.

### BACKGROUND

With the widespread adoption of new energy storage products like lithium batteries, garden tools have gradually shed their dependence on fixed power sources, achieving a significant shift toward portability and wireless operation. Common tools on the market today—such as lawn mowers, chainsaws, hedge trimmers, and garden blowers—largely feature rechargeable designs, enabling users to work flexibly and conveniently across various outdoor settings. Moreover, many users opt to carry separate battery packs as portable power sources, enabling quick recharging when tools run low on power.

Numerous existing portable power banks similar to garden battery packs support the PD protocol. PD (Power Delivery) is a high-speed power delivery protocol based on the USB Type-C interface, supporting up to 100 W power transfer. It enables dynamic negotiation of voltage and current, offering excellent compatibility and scalability.

However, existing garden battery packs feature separate charging and discharging ports: a dedicated charging port for recharging the device and a separate discharging port for powering external devices. This split-port design fails to leverage the advantages of the PD protocol and often suffers from the following drawbacks:

First, the multiple ports increase device complexity and bulk, hindering miniaturization and lightweight design. Second, users must carry corresponding interface cables, causing inconvenience and increasing risks of interface confusion or cable loss. Third, the circuit design for separate interfaces is relatively complex, raising production costs and failure risks. Finally, the lack of unified protocol coordination prevents adaptive matching of charging/discharging parameters, potentially leading to low charging efficiency and poor discharge compatibility.

### SUMMARY

The present disclosure provides a PD protocol-based charging and discharging common interface garden battery pack to overcome the limitations of current models.

According to some embodiments of the present disclosure, a PD protocol-based charging and discharging common interface garden battery pack is provided, including: an MCU control unit, wherein the MCU control unit is configured to perform logical control over the circuitry and further includes an MCU chip; a PD charge/discharge management unit for controlling charge/discharge logic, which includes a charge/discharge management chip electrically connected to the MCU chip to form a signal pathway; a battery pack unit for energy storage or discharge, connected to the MCU control unit and the PD charge/discharge management unit; wherein the MCU control unit further includes a charge/discharge switching unit connected to the MCU chip, used to switch the circuit's charge/discharge path; and the charge/discharge switching unit is connected to an interface unit, which includes an interface chip and an interface mechanical structure, the interface chip is connected to the charge/discharge switching unit and the charge/discharge management chip; the interface mechanical structure is connected to the interface chip, wherein the interface chip is configured to configure the interface mechanical structure, enabling devices connected to the interface mechanical structure to communicate and exchange energy with the MCU control unit, the PD charge/discharge management unit, and the battery pack unit; and the interface mechanical structure has terminals capable of connecting to devices; when the interface mechanical structure connects to a device, the charge/discharge management chip determines the device type based on its voltage and controls the charge/discharge switching unit to switch between charge/discharge logic or to disconnect the charge/discharge circuit.

In some embodiments, the charge/discharge switching unit includes a path switching circuit, and the path switching circuit includes a path switching MOSFET, the gate of the path switching MOSFET is connected to the charge/discharge management chip, the drain of the path switching MOSFET is connected to the battery pack unit and/or the interface unit, and the source of the path switching MOSFET is connected to the MCU control unit; the charge/discharge management chip controls the gate level of the path switching MOSFET based on the device voltage connected to the interface mechanical structure.

In some embodiments, the path switching circuit includes a sampling resistor connected to the drain of the path switching MOSFET, with the other end of the sampling resistor connected to the interface chip; and the charge/discharge management chip monitors the voltage across the sampling resistor to determine the voltage of the device connected to the interface mechanical structure, and monitors the current flowing through the sampling resistor.

In some embodiments, the MCU chip includes an ID identification terminal connected to an ID identification circuit, and the ID identification circuit is connected to the ID port of the interface chip; when the interface mechanical structure is connected to devices, the MCU chip determines the device type based on the device ID and sends a signal to the charge/discharge management chip to instruct the charge/discharge switching unit to switch the charge/discharge path.

In some embodiments, the path switching circuit further includes a filter circuit, and the filter circuit includes resistors and capacitors connected in series; the source of the path switching MOSFET is connected to the filter circuit, and the filter circuit is connected to the MCU chip to provide a filtered feedback signal to the MCU chip.

In some embodiments, five path switching circuits are provided, and the interface chip includes four ports B1, B2, B3, and B4, as well as a VBAT port; the drains of the five path switching MOSFETs are respectively connected to the B1, B2, B3, B4, and VBAT ports of the interface chip; the interface chip further includes an ID port connected to the MCU chip; the interface mechanical structure has four terminals respectively connected to the B1, B2, B3, and B4 ports of the interface chip; the interface mechanical structure also has a VBAT terminal connected to the VBAT port of the interface chip, and an ID terminal connected to the ID port of the interface chip.

In some embodiments, the path switching MOSFET employs an N-channel MOSFET.

In some embodiments, the sampling resistor is a precision resistor with a deviation accuracy of 1%.

In some embodiments, the MCU chip adopts the MM32F0141 microcontroller unit, and the charge/discharge management chip adopts the IP2369 chip.

In some embodiments, the charge/discharge management chip is connected to a charge/discharge switching MOSFET, and the charge/discharge management chip controls the conduction and disconnection of the charge/discharging switching MOSFET based on the device connected to the interface unit.

### BRIEF DESCRIPTION OF THE DRAWINGS

The accompanying drawings are provided to facilitate further understanding of the present disclosure and form part of the present disclosure. The illustrative embodiments and their descriptions are intended to explain the present disclosure and do not constitute undue limitations thereof. In the drawings:

FIG. 1 is a logic block diagram of the circuit principle according to some embodiments.

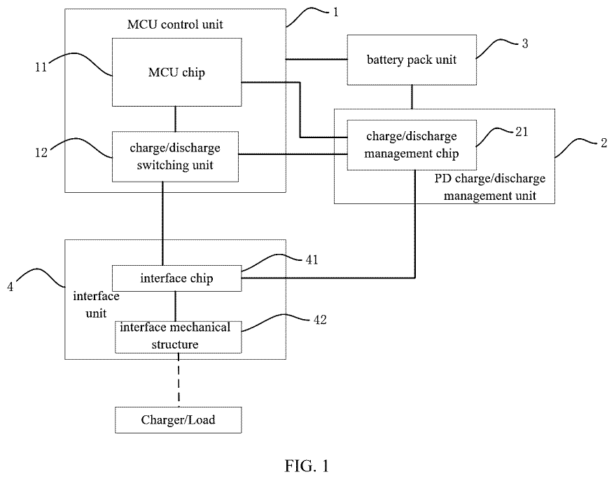

FIG. 2 is a circuit schematic diagram of the MCU control unit according to some embodiments.

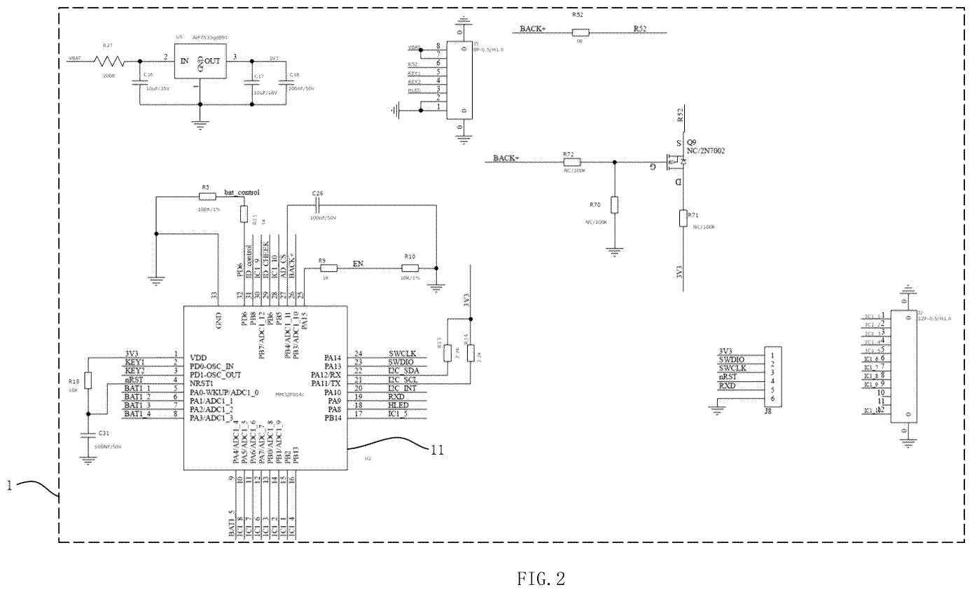

FIG. 3 is a circuit schematic diagram of the path switching circuit and ID recognition circuit within the MCU control unit according to some embodiments.

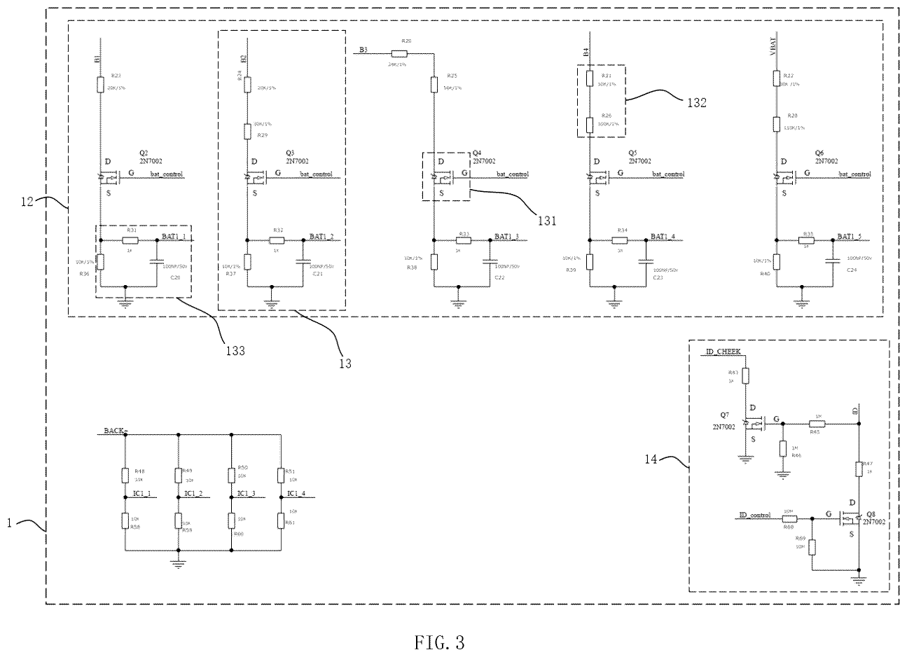

FIG. 4 is a circuit schematic diagram of the PD charge/discharge management unit according to some embodiments.

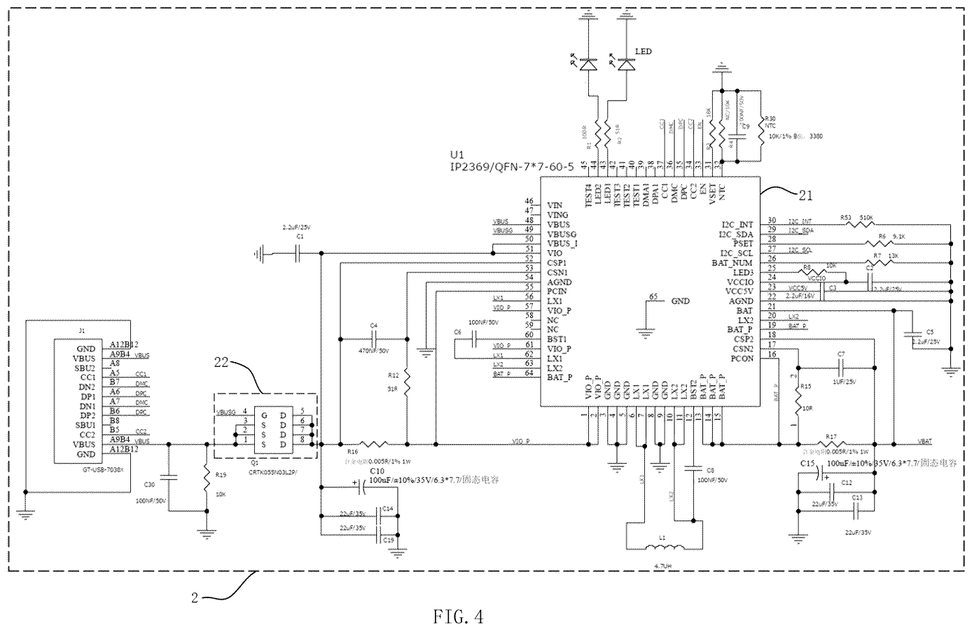

FIG. 5 is a circuit schematic diagram of the interface unit according to some embodiments.

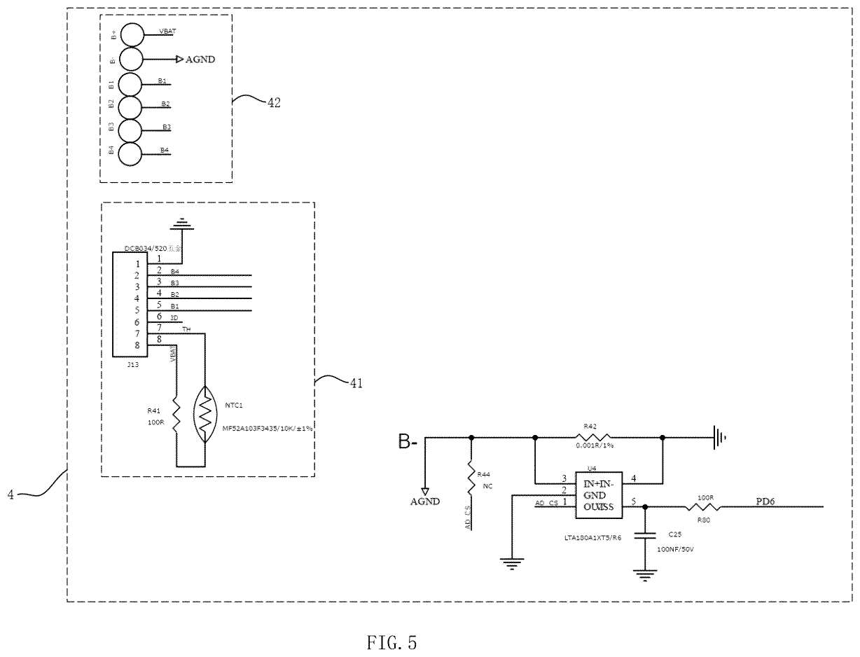

### DETAILED DESCRIPTION

To further illustrate the content, features, and efficacy of the present disclosure, the following embodiments are provided and described in detail with reference to the accompanying drawings:

### Embodiment 1

This embodiment discloses a PD protocol-based charging and discharging common interface garden battery pack for powering garden tools, which includes an MCU control unit 1, a PD charge/discharge management unit 2, and a battery pack unit 3. The PD charge/discharge management unit 2 is connected to the MCU control unit 1. The battery pack unit 3 is connected to both the MCU control unit 1 and the PD charge/discharge management unit 2. Specifically, the MCU control unit 1 performs logical control over the entire circuit, the PD charge/discharge management unit 2 controls the charging and discharging logic, and the battery pack unit 3 stores or discharges energy, supplying power to both the MCU control unit 1 and the PD charge/discharge management unit 2. The MCU control unit 1 includes an MCU chip 11. In this embodiment, the MCU chip 11 employs the MM32F0141 microcontroller unit. The PD charge/discharge management unit 2 includes a charge/discharge management chip 21. In this embodiment, the charge/discharge management chip 21 employs the IP2369 chip. The operating principles of the aforementioned MM32F0141 microcontroller and IP2369 chip are well-known to those skilled in the art and will not be elaborated upon here.

In the present disclosure, the MCU chip 11 and the charge/discharge management chip 21 are electrically connected to form a signal pathway for transmitting control signals and commands. Additionally, the MCU control unit 1 is connected to an interface unit 4, which is also connected to the PD charge/discharge management unit 2. The interface unit 4 facilitates connection to external power sources or electrical devices, ensuring physical compatibility with them. It switches operating modes based on instructions from the MCU control unit 1 and the charge/discharge management chip 21: When the interface unit 4 is connected to an external power source, the circuit logic of the MCU control unit 1 and the PD charge/discharge management unit 2 can identify this external power source and switch to charging mode, enabling the external power source to charge the battery pack unit 3. When the interface unit 4 is connected to a power-consuming device, the circuit logic of the MCU control unit 1 and the PD charge/discharge management unit 2 can identify the load and switch to discharge mode, enabling the battery pack unit 3 to supply power to the external load. Both charging and discharging functions are achieved through a single interface unit 4, eliminating the need for separate interfaces for charging and discharging. This simplifies the device structure while enhancing usability and compatibility.

Specifically, the MCU control unit 1 further includes a charge/discharge switching unit 12 connected to the MCU chip 11. The charge/discharge switching unit 12 is also connected to the charge/discharge management chip 21. Its internal circuitry directly performs path switching between charge and discharge operating modes under instructions from the MCU chip 11 and the charge/discharge management chip 21. To identify different devices connected to the interface unit 4, the charge/discharge switching unit 12 connects to the interface unit 4. The interface unit 4 includes an interface chip 41 and an interface mechanical structure 42. The interface mechanical structure 42 directly connects to a charger or load, with its pins directly linked to the interface chip 41. In this embodiment, the interface chip 41 is model DCB034/520. It features four ports—B1, B2, B3, and B4—connected to the charge/discharge switching unit 12, along with a VBAT port connected to the battery power output terminal VBAT of the charge/discharge management chip 21. Additionally, it includes an ID port for identifying the device after connection. Correspondingly, the interface mechanical structure 42 has four terminals B1, B2, B3, and B4 connected to the interface chip 41, along with a VBAT terminal for routing the battery power output VBAT from the charge/discharge management chip 21. The interface mechanical structure 42 also includes an ID terminal (not shown in the figure), which connects to the ID port of the interface chip 41. The aforementioned terminals of the interface mechanical structure 42 may be gold fingers, metal contacts, or any other electrically conductive structure capable of connecting to a USB power connector compatible with the PD protocol.

The charge/discharge management chip 21 is connected to a charge/discharge switching MOSFET 22 designated as Q1. The charge/discharge switching MOSFET 22 is a P-channel MOSFET whose gate G is controlled by the circuit logic of the charge/discharge management unit 2. When an external PD charger is connected to the interface unit 4, Q1 conducts, allowing the VBUS voltage (charger input) to be transmitted to the VBUS pin of the charge/discharge management chip 21. This supplies power to the PD charge/discharge management unit 2 and charges the battery pack unit 3. When the charger is disconnected, Q1 can interrupt the VBUS path, preventing reverse current or interference. During anomalies such as overvoltage or overcurrent, the charge/discharge management chip 21 can control the gate voltage of Q1 to turn it off, thereby disconnecting the VBUS input and assisting in implementing overvoltage/overcurrent protection during the charging process.

The charge/discharge switching unit 12 includes five path switching circuits 13, each connected to one of the five terminals of the interface chip 41. Each path switching circuit 13 includes a path switching MOSFET 131, specifically Q2, Q3, Q4, Q5, and Q6. In this embodiment, the path switching MOSFET 131 employs a 2N7002N-channel MOSFET, featuring a source S, drain D, and gate G. The gate G controls the conduction between the source S and drain D. When the gate G is at a high level, the circuit between the source S and drain D is turned on. The gate G is connected to the control pin of the charge/discharge management chip 21 (not shown in the figure). When the control pin of the charge/discharge management chip 21 outputs a high level to the gate G, the source S and drain D are electrically connected. When the control pin of the charge/discharge management chip 21 outputs a low level to the gate G, the source S and drain D are mutually blocked. Thus, when the control level received by the gate G changes, the charge/discharge switching unit 12 can switch its operating mode based on the aforementioned control signal, thereby switching the path switching circuit 13 to the charging, discharging, or disconnected mode.

Furthermore, the path switching circuit 13 also includes a sampling resistor 132 connected to the drain D of the path switching MOSFET 131, where the sampling resistor 132 employs a precision resistor with a deviation accuracy of 1%. The other end of the sampling resistor 132 is connected to the corresponding port of the interface chip 41. In this embodiment, the drains D of the path switching MOSFET 131 numbered Q2-Q5, after being connected with the sampling resistor 132, are respectively connected to the ports B1-B4 of the interface chip 41. The drain D of path switching MOSFET 131 numbered Q6 is connected with sampling resistor 132 and then connected to the VBAT port of interface chip 41. The aforementioned sampling resistor 132 can, on the one hand, provide overcurrent protection for the circuit. On the other hand, the sampling resistor 132 connected to the VBAT terminal of the interface mechanical structure 42 also functions as a voltage divider resistor. It performs voltage division sampling on the VBAT terminal. When a device is connected to the interface mechanical structure 42, the charge/discharge management chip 21 monitors the voltage across the voltage divider resistor to determine whether an external power source or load is connected. It then sends corresponding signals to the path switching circuit 13 to switch the charge/discharge mode.

Furthermore, the path switching circuit 13 also includes a filter circuit 133. The source terminal S of each path switching MOSFET 131 is connected to one such filter circuit 133. The filter circuit 133 includes a resistor and a capacitor connected in series. The source S of the path switching MOSFET 131 is connected to the MCU chip 11 via the filter circuit 133, thereby providing a feedback signal to the MCU chip 11. The filter circuit 133 filters out voltage ripple during charging and discharging, stabilizing the voltage at the VBAT terminal and the battery pack unit 3. This ensures a stable electrical signal for the MCU chip 11, preventing abnormal mode switching caused by voltage fluctuations.

The MCU chip 11 features an ID identification terminal connected to an ID recognition circuit 14. This ID recognition circuit 14 is also linked to the ID port of the interface chip 41. When a charging device or electrical load connects to the interface mechanical structure 42, the MCU chip 11 can identify the device's identity via the ID recognition circuit 14. This assists the charge/discharge management chip 21 in switching between charge/discharge modes. When the identification result from the MCU chip 11 conflicts with the high/low voltage identification result from the charge/discharge management chip 21, the MCU chip 11 issues a command to the charge/discharge management chip 21 to block the path switching circuit 13, preventing charging or discharging. This achieves device protection, meaning the MCU chip 11 can act based on the negotiation results from the PD protocol interaction unit and the parameters collected by the status monitoring unit.

This embodiment achieves the working principle of a common charging and discharging interface as follows:

### Scenario 1

When an external PD-compliant power adapter is connected to the interface mechanical structure 42, the VBAT pin of the charge/discharge management chip 21 detects that the external power supply voltage exceeds the voltage of the battery pack unit 3;

Simultaneously, the MCU chip 11 identifies the charger device via the ID pin, and the charge/discharge management chip 21 samples the VBAT terminal voltage through the sampling resistor 132, confirming entry into charging mode; The charge/discharge management chip 21 outputs a drive signal to control the charge/discharge switching MOSFET 22 (designated Q1) to turn on, enabling charging of battery pack unit 3 via the external power source. At this point, the current flows in the charging direction;

Current path during charging: PD power adapter→interface unit 4→charge/discharge switching unit 12→PD charge/discharge management unit 2→battery pack unit 3.

The charge/discharge management chip 21 continuously monitors charging current and voltage, automatically switching between constant-current and constant-voltage phases. Upon detecting full charge in battery pack unit 3, the chip outputs a drive signal to cut off charge/discharge switching MOSFET 22 (designated Q1), thereby disconnecting the charging circuit to protect the device.

### Scenario 2

When an external electrical load device is connected to the interface mechanical structure 42, the VBAT pin of the charge/discharge management chip 21 detects that the external voltage is lower than the voltage of the battery pack unit 3;

At this point, the MCU chip 11 identifies the external load device via the ID pin, and the charge/discharge management chip 21 samples the VBAT terminal voltage through the sampling resistor 132, confirming entry into discharge mode;

The charge/discharge management chip 21 outputs a drive signal to control the charge/discharge switching MOSFET 22 (designated as Q1) to conduct, enabling power supply from battery pack unit 3 to the external load. The current direction at this point is discharge;

Current path during discharge: battery pack unit 3→PD charge/discharge management unit 2→charge/discharge switching unit 12→interface unit 4→external load;

The charge/discharge management chip 21 continuously monitors both charging and discharging currents. Upon detecting a load short circuit or overcurrent condition, it outputs a signal to cut off the charge/discharge switching MOSFET 22 (designated as Q1), thereby disconnecting the discharge circuit to protect both the device and the load.

In this embodiment, the device can automatically switch between charging and discharging modes through voltage detection by the charge/discharge management chip 21 and ID recognition by the MCU chip 11. It directly controls the charging/discharging circuit via the charge/discharge switching MOSFET 22 within the PD charge/discharge management unit 2. The interface unit 4 physically requires no distinction between charging and discharging ports, significantly enhancing user convenience, simplifying device structure, and improving both usability and product compatibility.

The above are merely embodiments of the present disclosure and are not intended to limit the scope of the present disclosure. For those skilled in the art, the present disclosure may be subject to various modifications and variations. Any modifications, equivalent substitutions, improvements, etc., made within the spirit and principles of the present disclosure shall be included within the scope of the appended claims.

1. A PD protocol-based charging and discharging common interface garden battery pack, comprising:
an MCU control unit, wherein the MCU control unit is configured to perform logical control over the circuitry and further comprises an MCU chip;
a PD charge/discharge management unit for controlling charge/discharge logic, which comprises a charge/discharge management chip electrically connected to the MCU chip to form a signal pathway;
a battery pack unit for energy storage or discharge, connected to the MCU control unit and the PD charge/discharge management unit;
wherein the MCU control unit further comprises a charge/discharge switching unit connected to the MCU chip, used to switch the circuit's charge/discharge path; and
the charge/discharge switching unit is connected to an interface unit, which comprises an interface chip and an interface mechanical structure, the interface chip is connected to the charge/discharge switching unit and the charge/discharge management chip; the interface mechanical structure is connected to the interface chip, wherein the interface chip is configured to configure the interface mechanical structure, enabling devices connected to the interface mechanical structure to communicate and exchange energy with the MCU control unit, the PD charge/discharge management unit, and the battery pack unit; and
the interface mechanical structure has terminals capable of connecting to devices;
when the interface mechanical structure connects to a device, the charge/discharge management chip determines the device type based on its voltage and controls the charge/discharge switching unit to switch between charge/discharge logic or to disconnect the charge/discharge circuit.

2. The PD protocol-based charging and discharging common interface garden battery pack according to claim 1, wherein the charge/discharge switching unit comprises a path switching circuit, and the path switching circuit comprises a path switching MOSFET, the gate of the path switching MOSFET is connected to the charge/discharge management chip, the drain of the path switching MOSFET is connected to the battery pack unit and/or the interface unit, and the source of the path switching MOSFET is connected to the MCU control unit; the charge/discharge management chip controls the gate level of the path switching MOSFET based on the device voltage connected to the interface mechanical structure.

3. The PD protocol-based charging and discharging common interface garden battery pack according to claim 2, wherein the path switching circuit comprises a sampling resistor connected to the drain of the path switching MOSFET, with the other end of the sampling resistor connected to the interface chip; and the charge/discharge management chip monitors the voltage across the sampling resistor to determine the voltage of the device connected to the interface mechanical structure, and monitors the current flowing through the sampling resistor.

4. The PD protocol-based charging and discharging common interface garden battery pack according to claim 3, wherein the MCU chip comprises an ID identification terminal connected to an ID identification circuit, and the ID identification circuit is connected to the ID port of the interface chip;
when the interface mechanical structure is connected to devices, the MCU chip determines the device type based on the device ID and sends a signal to the charge/discharge management chip to instruct the charge/discharge switching unit to switch the charge/discharge path.

5. The PD protocol-based charging and discharging common interface garden battery pack according to claim 2, wherein the path switching circuit further comprises a filter circuit, and the filter circuit comprises resistors and capacitors connected in series; the source of the path switching MOSFET is connected to the filter circuit, and the filter circuit is connected to the MCU chip to provide a filtered feedback signal to the MCU chip.

6. The PD protocol-based charging and discharging common interface garden battery pack according to claim 4, wherein five path switching circuits are provided, and the interface chip comprises four ports B1, B2, B3, and B4, as well as a VBAT port; the drains of the five path switching MOSFETs are respectively connected to the B1, B2, B3, B4, and VBAT ports of the interface chip; the interface chip further comprises an ID port connected to the MCU chip;
the interface mechanical structure has four terminals respectively connected to the B1, B2, B3, and B4 ports of the interface chip; the interface mechanical structure also has a VBAT terminal connected to the VBAT port of the interface chip, and an ID terminal connected to the ID port of the interface chip.

7. The PD protocol-based charging and discharging common interface garden battery pack according to claim 6, wherein the path switching MOSFET employs an N-channel MOSFET.

8. The PD protocol-based charging and discharging common interface garden battery pack according to claim 3, wherein the sampling resistor is a precision resistor with a deviation accuracy of 1%.

9. The PD protocol-based charging and discharging common interface garden battery pack according to claim 1, wherein the MCU chip adopts the MM32F0141 microcontroller unit, and the charge/discharge management chip adopts the IP2369 chip.

10. The PD protocol-based charging and discharging common interface garden battery pack according to claim 1, wherein the charge/discharge management chip is connected to a charge/discharge switching MOSFET, and the charge/discharge management chip controls the conduction and disconnection of the charge/discharging switching MOSFET based on the device connected to the interface unit.
